(19) United States
(12) Patent Application Publication
(10) Pub. No.: US 2017/0324462 A1
(43) Pub. Date: Nov. 9, 2017

(54) UNIFIED INTERFERENCE REJECTION COMBINING

(71) Applicant: ZTE Canada Inc., Toronto (CA)

(72) Inventors: Dayong Chen, Kitchener (CA); Yiwen Liu, Waterloo (CA)

(21) Appl. No.: 15/531,402

(22) PCT Filed: Nov. 25, 2015
(86) PCT No.: PCT/CA2015/051234

§ 371 Date: May 26, 2017

Related U.S. Application Data
(60) Provisional application No. 62/085,469, filed on Nov. 28, 2014.

(51) Int. Cl. H04B 7/08; H04B 7/0456; H04L 1/00; H04W 28/04

(52) U.S. Cl. CPC H04B 7/08; H04W 28/048; H04B 7/0456; H04L 1/0036

(57) ABSTRACT

A receiver for demodulating wireless signal using multiple receive antennas includes multiple signal detection modules, with each module implementing a non-interference rejection combining signal detection technique. The receiver makes a decision about whether or not to use an interference rejection combining technique, and which signal detection module to use based on the operating conditions of the received signals. When the decision is made to use an interference rejection combining technique, a single whitening filter is used to whiten the received signal prior to sending the whitened signal for processing by the signal detection module. The whitening filter may be calculated as a Cholesky decomposition of an impairment covariance matrix generated from the signals received at the multiple antennas.

### CROSS REFERENCE TO RELATED APPLICATIONS

This patent document claims the benefit of priority of U.S. Provisional Patent Application No. 62/085,469, filed on Nov. 28, 2014. The entire content of the before-mentioned patent application is incorporated by reference as part of the disclosure of this application.

### TECHNICAL FIELD

The present document relates to wireless communication, and in one aspect, to signal processing performed in a wireless signal receiver.

### BACKGROUND

Recent years has seen a significant growth in wireless communication. As the number of wireless devices and applications running on the wireless devices goes up, so does the demand for data bandwidth in wireless communication networks. To meet this growing demand for high performance wireless devices and networks, complexity of next generation wireless networks and devices is expected to significantly increase over the currently deployed wireless devices.

### SUMMARY

A method and apparatus of interference rejection combining (IRC) comprises the steps of selecting a detection algorithm based on the signal to interference and noise ratio, generating real- or complex-valued impairment covariance matrix depending on the selected algorithm, calculating an interference reduction metric and comparing the metric with a threshold to determine if IRC shall be enabled, and if IRC is enabled, generating a whitening filter, applying the whitening filter to the received signal and channel matrix, and passing the whitened received signal and channel matrix to the selected standard detection algorithm for signal demodulation.

In one example aspect, a method of recovering data from a received signal implemented at a receiver comprising multiple receiving antennas is disclosed. The method includes estimating a signal to interference and noise ratio (SINR) of a received signal, selecting, based on the estimated SINR, one of a plurality of detection algorithms available for implementation at the receiver, determining a value of an interference reduction metric, selectively applying a whitening filter to the received signal, wherein the whitening filter is applied only when the value of the interference reduction metric meets a switching criterion, and operating the selected one of the plurality of detection algorithm upon an output of the whitening filter to generate estimates of bits of the data from the received signal. At least some of the plurality of detection algorithms have different error rate performances and different computational complexities. The whitening filter de-correlates received interference over the multiple receiving antennas by using spatial correlation of the impairment on multiple receiving antennas.

In another example aspect, a wireless communication receiver to adaptively demodulate a received signal is disclosed. The receiver includes an algorithm control unit that selects one from a plurality of signal detection algorithms available at the receiver, an interference rejection combining (IRC) control unit that determines whether or not to use IRC for the demodulation of a received signal using a detection algorithm that uses spatial correlation among impairment signals that form a part of the received signals, a whitening filter generation unit that computes coefficients of a whitening filter from an estimated impairment correlation matrix and a whitening filter unit that performs, prior to signal detection by the selected one of the plurality of signal detection algorithms, signal filtering using the whitening filter.

In yet another example aspect, a method of decoding data modulated using an orthogonal frequency division multiplexing (OFDM) technique, implemented at a receiver having multiple receive antennas, includes receiving the OFDM signal over multiple antennas, determining a spatial correlation of the impairment component of the received signals, generating coefficients of a whitening filter based on the determined spatial correlation of the impairment, applying the whitening filter to the received signal for de-correlating impairment in the received signal, and performing symbol detection on the de-correlated signal using one of a plurality of signal detection circuits that do not take into account spatial correlation among impairment component signals.

In yet another example aspect, a technique for recovering data from a received signal that includes an interference component is disclosed. The technique may be implemented at a receiver comprising multiple receiving antennas. The technique includes estimating, at the receiver, an impairment covariance matrix for signals received at the multiple receiving antennas, wherein the impairment covariance matrix represents a statistical covariance of the interference plus thermal noise component of the received signal, computing a Cholesky decomposition of the impairment covariance matrix by using one of an upper- and a lower-triangular Cholesky factor matrix depending on relative power levels of impairment component of the signals received at the multiple receiving antennas, generating a whitening filter from the Cholesky decomposition, wherein the whitening filter de-correlates received interference over the multiple receiving antennas by using spatial correlation of the impairment signals across the multiple receiving antennas, applying the whitening filter to the received signal, and operating a detection algorithm upon an output of the whitening filter to generate estimates of bits of the data from the received signal.

These, and other, aspects are disclosed in the present document.

### BRIEF DESCRIPTION OF THE DRAWINGS

FIG. 1 shows an example of a wireless communication system in which inter-cell interference is present.

FIG. 2 shows an example of a multi-input, multi-output (MIMO) receiver.

FIG. 3 shows an example of a MIMO receiver that includes Interference Rejection Combining (IRC) control units.

FIG. 4 shows an example of a MIMO receiver with a unified IRC unit.

FIG. 5 shows an example flowchart representation of a process of receiving and decoding digital signals.

FIG. 6 shows an example flowchart representation of a process of demodulating an orthogonal frequency division multiplexing (OFDM) signal.

FIG. 7 depicts examples of signal processing matrices used during signal reception in a wireless communication receiver.

FIG. 8 shows an example flowchart of a method of recovering data from a signal received at multiple receive antennas.

### DETAILED DESCRIPTION

In recent years, the use of multiple antennas at the transmitter and/or receiver, sometimes collectively called Multiple Input, Multiple Output (MIMO) systems, has become a pragmatic and cost-effective approach in making high data rate wireless links a reality. To further increase system capacity, wireless service providers deploy networks employing 1/1 frequency reuse. The frequency reuse, however, could result in an increase in interference from neighbor cells, causing undesirable effects such as lower data throughput, poor speech quality, call dropout, etc. As a result, effective interference suppressing algorithms in the wireless MIMO receivers have become increasingly important to improve user throughput, especially in cell-edge regions where signals from neighboring cells may overlap with the desired signal. Inter-cell interference mitigation is an important issue in cellular networks in general, and is important in 4G and upcoming networks because the way to meet the exponentially growing traffic need is by hyper-dense deployment of cells with low power cells overlaying high power macro cells. In such heterogeneous networks (HetNets), received signal level from a neighbor cell can be much higher than that of the serving cell if the mobile user equipment is located at cell edge. An Interference Rejection Combining (IRC) implementation may make use of correlation of interference across multiple receiver antennas to reduce the effect of the interference. For example, an IRC receiver based on minimum mean square error criterion, referred to as MMSE-IRC advanced receiver, was introduced in Release 11 of the 3GPP LTE (3rd Generation Partnership Project Long Term Evolution) Advanced standard (LTE-A). Per LTE-A Release 11, an IRC receiver is to meet enhanced requirements for radio signal reception in which the signal is impaired not only by thermal noise but also interference from neighbor cells. In LTE Release 12, an even more advanced class of receivers called Network Assisted Interference Cancellation an Suppression (NAICS) is introduced to mitigate even more interference by explicitly cancelling the strongest interference signal(s), or by jointly detecting interference and desired signal. An NAICS receiver can be used to mitigate strong neighbor cell interference signals whereas weaker interference signals can be suppressed more effectively using IRC.

In comparison with non-IRC based techniques, IRC techniques, e.g., as specified in Release 11, may put a significant implementation burden on receivers. To add to this, when a receiver is designed to implement multiple IRC techniques, or a mix of IRC and conventional techniques, the circuit area, power consumption, and complexity of implementation may significantly increase.

In some implementations that use the IRC technique, the spatial correlation of the impairment (interference plus noise) observed on two or more receive antennas is used to suppress the power of the interference. The spatial correlation of impairment component is estimated by calculating individual impairment samples and averaging the impairment samples wherein each impairment sample either includes all received interference signals plus noise, or a subset of all the interference signals plus noise, depending on if the selected detection algorithm detects an interference signal. If the selected detection algorithm detects an interference signal, in addition to detecting the desired user signal, then the interference signal is not included in the impairment sample and vice versa. By comparison, some interference cancellation (IC) techniques, e.g., the NAICS receiver technique, explicitly estimate one or more parameters of the interfering signal(s) including their channel matrix and modulation scheme, in addition to estimating the parameters of the desired signal. In some IC implementations, the estimated interfering signal is then subtracted from the received signal to reduce the impact of the interference. The resulting difference signal is demodulated to recover the information bits in the desired signal. In contrast to IC, an IRC receiver can work by simply exploiting the spatial correlation of the impairment component of the received signal, and thus can provide a more robust and cost-effective receiver implementation compared to an IC-based implementation.

The techniques described in the present document can be used for interference suppression in a wireless MIMO-OFDM (Orthogonal Frequency Division Multiplexing) receiver as part of received signal processing. In one aspect, the disclosed techniques can be used to unify IRC using different detection algorithms, including NAICS detection algorithms based on either interference cancellation and joint detection. In one advantageous aspect, the disclosed technique enable a simple migration of current and future receiver designs to incorporate spatial correlation of the impairment among signals received at multiple antennas into the signal detection and symbol decision algorithms.

The disclosed techniques may be implemented by pre-filtering signals, prior to symbol decisions, using a whitening filter that spatially de-correlates the impairment in the received signals. The whitening filter can be calculated by performing decomposition of the impairment correlation matrix resulting in a triangular whitening matrix.

In many implementations, demodulation is performed for each subcarrier independently, except for transmit diversity mode, where demodulation is done for a pair of adjacent subcarriers. The high complexity of MIMO demodulator is due to the very large number of subcarriers that have to be demodulated in every data frame of short duration. The demodulator can generate a heavy computation load even using a simple algorithm if the algorithm is executed at a high rate. To be able to provide satisfactory performance under different operating conditions, a practical demodulator is typically designed to support an array of different detection algorithms to cover different transmission modes, to reduce power consumption and/or to achieve optimum error rate performance. In some cases, for certain operating conditions, a low-complexity algorithm has better performance than a high-complexity algorithm(s). In other cases, it may be useful to use high-complexity algorithm in order to meet the standard requirements and to achieve high data throughput.

In some disclosed embodiments, an IRC receiver is used in combination with a NAICS receiver wherein the strongest interference signal(s) is/are detected using a NAICS receiver algorithm, whereas weaker interference signals are suppressed using IRC. If a strong interference is to be detected using a NAICS algorithm, this interference signal is not included in the impairment correlation calculation.

Different MIMO detection algorithms including NAICS detection algorithms can be categorized based on their design criteria and impairment models. For example, algorithms using uncorrelated and correlated impairment model can be referred to as standard algorithms and IRC algorithms, respectively. For example, an implementation that based on the criterion of minimizing Mean Squared Error (MSE) using uncorrelated impairment model may be called a standard MMSE implementation whereas an implementation which minimizes MSE using correlated impairment model may be called MMSE-IRC. A Maximum Likelihood (ML) implementation may maximize the Maximum A Posteriori Probability (MAP) using uncorrelated impairment model, whereas a ML-IRC algorithm also maximizes MAP, but uses correlated impairment model. Similarly, a NAICS receiver using successive interference cancellation may use MMSE to first detect neighbor cell signal, subtract the detected interference from received signal and then detect the desired signal. In some implementations, different IRC techniques may be implemented by separately incorporating the inverse of impairment covariance matrix into a corresponding standard, or non-IRC, algorithms. Such implementations may entail significant changes to the existing, or pre-Release 11, modem chips that typically support only the standard non-IRC detection techniques. A MIMO receiver may have to support both IRC and non-IRC mode operation because the IRC gain depends on prevalent interference situation, for example using IRC mode detection in cell center can reduce rather than increase the user data throughput due to the limited accuracy achievable using practical channel and impairment matrix estimation algorithm.

Orthogonal Frequency Division Multiplexing (OFDM) can be used to convert frequency selective fading radio channel into frequency flat fading channel. The transmitter sends K modulation symbols in parallel during an OFDM symbol l (l=0,1, . . . L−1, where L is the number of OFDM symbols per timeslot) using N_{FFT} (N>L) sub-carriers. Due to the orthogonality of the subcarriers, the receiver can demodulate received signal r_{l,k} for each data-carrying subcarrier independently. In OFDM terminology, e.g., as used in the 3GPP documents, the smallest unit of time-frequency resource is called a Resource Element (RE). The demodulation of a single subcarrier is relatively simple since r_{l,k} is the transmitted modulation symbol s_{l,k} multiplied by the channel frequency response h_{l,k} plus a noise term v_{l,k}.

r_{l,k}=h_{l,k}s_{l,k}+v_{l,k} Eq. 1

Let N_{RX} and N_{D} denote the number of receive antennas and transmitted layers, respectively. The use of OFDM can greatly simplify MIMO system design and implementation because the N_{RX}×1 received signal vector is the N_{D}×1 transmitted symbol vector x_{l,k} multiplied by the N_{RX}×N_{D} channel frequency response matrix H_{l,k} plus a N_{RX}×1 noise vector n_{l,k}:

y_{l,k}=H_{l,k}x_{l,k}+n_{l,k} Eq. 2

Depending on the transmission mode being used, the vector x_{l,k} may have been pre-coded at the transmitter using a N_{TX}×N_{D} pre-coding matrix, and the resulting signal is transmitted through N_{TX} transmit antennas. Whether or not pre-coding is performed, H always refers to the composite channel matrix between N_{RX} received signals and N_{D} transmitted symbols. In the following description, the OFDM symbol and subcarrier indices l and k are omitted for brevity, but it should be understood that, in a broadband system, a MIMO receiver needs to demodulate signals y for potentially a very large number of resource elements to complete the reception of a single data packet. This is the reason why MIMO demodulator is one of the most complex components of a receiver.

In a typical MIMO-OFDM system, the total frequency resource (spectrum) is divided into resource blocks (RBs) where each RB consists of a certain number of frequency-consecutive subcarriers during a specific number of time-consecutive OFDM symbols. Within a Transmit Time Interval (TTI), the transmitter sends different types of signals using a specific number of RBs. A small portion of the allocated resource grid (time-frequency grid) is used to transmit Synchronization Signals (SS), Reference Signals (RSs), and control channels. The SS are typically used for time-frequency synchronization; RSs are typically used for channel estimation and channel quality measurement; and control channels carry information useful to demodulate and decode the user data. The larger part of the grid is used to transmit user data using one of the supported transmission modes, including transmit diversity, open- and closed-loop spatial multiplexing and beamforming, etc.

The impairment vector n, which includes interference and thermal noise on N_{RX} receive antennas, can be modeled as uncorrelated or correlated random vector. In the first case, the impairment covariance matrix R is the identity matrix scaled by noise variance δ²

R=E{nn^{H}}=δ²I_{N}_{_{RX}} Eq. 3

where, E{} and ^{H} denote expectation and transpose-conjugate operator respectively. In the second case, the impairment is modeled as a Hermitian matrix with non-zero off-the-diagonal entries:

$$R = E \{ {nn}^{H} \} = [ \begin{matrix}E \{ n ( 0 ) {n}^{*} ( 0 ) \} & E \{ n ( 0 ) {n}^{*} ( 1 ) \} & … & E \{ n ( 0 ) {n}^{*} ( {N}_{RX} - 1 ) \} \\ E \{ n ( 1 ) {n}^{*} ( 0 ) \} & E \{ n ( 1 ) {n}^{*} ( 1 ) \} & … & E \{ n ( 1 ) {n}^{*} ( {N}_{RX} - 1 ) \} \\ … & … & … & … \\ E \{ n ( {N}_{RX} - 1 ) {n}^{*} ( 0 ) \} & E \{ n ( {N}_{RX} - 1 ) {n}^{*} ( 1 ) \} & … & E \{ n ( {N}_{RX} - 1 ) {n}^{*} ( {N}_{RX} - 1 ) \}\end{matrix} ] \qquad Eq . 4$$

Eq. 3 can be a good model when the impairment only contains thermal noise or if the level of the interference is negligible or if there are a large number of interferers of approximately the same power level. However, if there are several dominant interfering signals, the receiver design should be based on (Eq. 4); otherwise radio performance may degrade significantly.

If there is only one interfering neighbor cell, the impairment can be written as

n=H ₂x₂+w Eq. 5

where H₂, x₂ represent the channel matrix and the transmitted symbol vector from the interfering neighbor cell respectively, and w the thermal noise. The corresponding impairment covariance matrix is given by

R=E{nn^{H}}=E{(H₂x₂+w)(H₂x₂+w)^{H}=E{H}₂H₂²}+E{ww^{H}}=E{H₂H₂²}+δ²I_{N}_{_{RX}} Eq. 6

The following assumptions are used to obtain (Eq. 6):(1) the interfering signal x₂ and thermal noise are un-correlated, (2) the covariance matrix of x₂ is an identity matrix, and (3) the covariance matrix of w is δ²I_{N}_{_{RX}}.

IRC uses the impairment correlations across receive antennas to suppress interference. For example, if H₂ in (Eq. 6) is a 2×1 matrix H₂=[h₀₀ h₁₀]^{T}, then the impairment covariance matrix can be expressed as:

$$R = E \{ {H}_{2} {H}_{2}^{2} \} + {δ}^{2} {I}_{{N}_{RX}} = [ \begin{matrix}E {\vert {h}_{00} \vert}^{2} + {δ}^{2} & E \{ {h}_{00} {h}_{10}^{*} \} \\ E \{ {h}_{10} {h}_{00}^{*} \} & E {\vert {h}_{10} \vert}^{2} + {δ}^{2}\end{matrix} ] \qquad Eq . 7$$

The off-the-diagonal entries of the above covariance matrix are non-zero, because the channel coefficients of the interference signal h₀₀ and h₁₀ are correlated. To estimate the impairment covariance matrix, the vector e_{l,k}=[e_{l,k}(0), e_{l,k}(1), . . . e_{l,k}(N_{RX}−1)]^{T} of impairment samples is computed using the known reference signal symbols:

e_{l,k}=y_{l,k}−Hd_{l,k}, (l,k)⊂Ψ_{RS} Eq. 8

where Ψ_{RS} is the set of reference signal symbol indices and d_{l,k} are known RS symbols and H is the estimated channel matrix. The noise covariance matrix estimate R is computed as:

$$R = \frac{1}{\vert {Ψ}_{RS} \vert} {\sum }_{( l , k ) ∈ {Ψ}_{RS}} {e}_{l , k} {e}_{l , k}^{H} , \qquad Eq . 9$$

where |Ψ_{RS}| denotes the number of RS symbols. If there are multiple interference signals with ^{k}l^{f}Rs channel matrices H₂, H₃, . . . Hₗ₊₁, and corresponding transmit symbol vectors x₂, x₃, . . . x₁₊₁ and the strongest interference H₂x₂ are to be detected using a NAICS algorithm, then an impairment sample can be calculated as below where d_{l,k}⁽²⁾ denotes the RS symbols of the strongest interference signal.

e_{l,k}=y−Hd_{l,k}−H₂d_{l,k}⁽²⁾

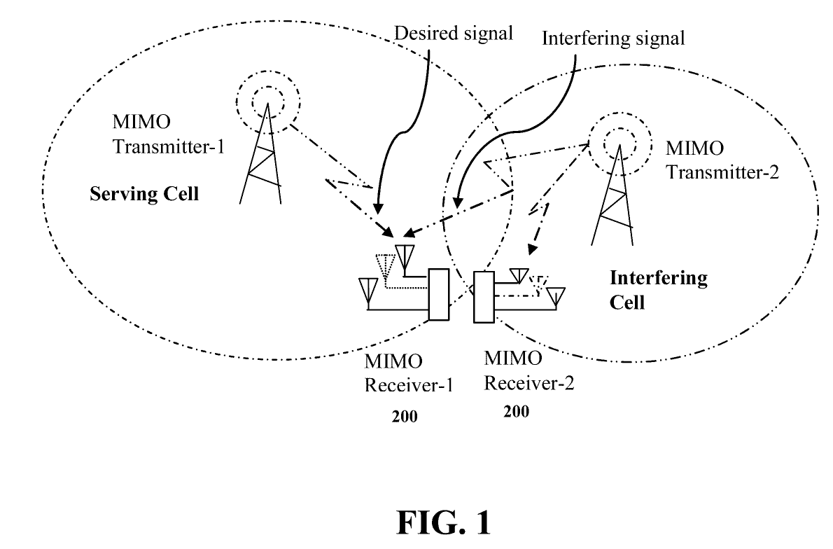

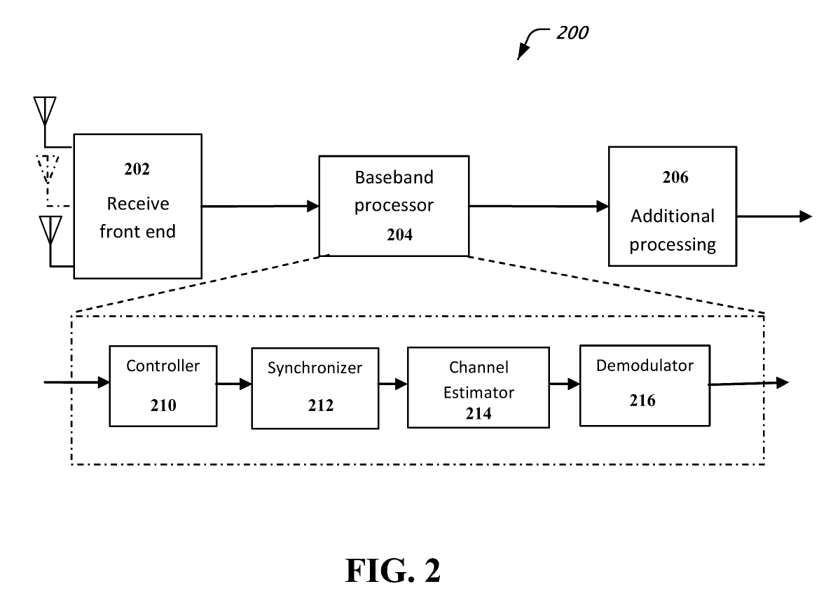

FIG. 2 illustrates an exemplary MIMO receiver 200 shown in (FIG. 1) which consists of a radio frontend 202, a baseband processor 204, and a block 206 used for further processing of the received signal. The frontend 202 down-converts each of the N_{RX} received signals to baseband, removes Cyclic Prefix (CP) for a block of samples representing an OFDM symbol, and performs Fast Fourier Transform (FFT) to convert the received signal to frequency domain. The baseband processor 204 consists of a controller 210, a synchronizer 212, a channel estimator 214, and a MIMO demodulator 216.

The controller 210 de-maps the received signals to different physical channels, extracts physical signals, and controls the overall baseband processing. The synchronizer 212 performs time-frequency synchronization of the receiver 200 which is used to maintain orthogonality of the received signals on different subcarriers. Channel estimator 214 picks up received reference signals to estimate the channel matrix at the time-frequency locations corresponding to the reference signals, and then interpolates/extrapolates these channel samples to estimate the channel matrix at resource elements corresponding to data symbols. To use a NAICS algorithm, the channel estimator needs to estimate channel matrix of one or more strongest neighbor cells. The channel estimator 214 also estimates the noise variance \hat{δ}² and, if interference rejection combining is supported, the impairment covariance matrix \hat{R}. The demodulator 216 uses the received signals, channel matrices, noise variance, and impairment covariance matrix estimate provided by the channel estimator to detect the transmit symbols \hat{x} and calculate the log-likelihood ratios (LLRs) for each bit in the detected symbols. The LLRs are forwarded to the Viterbi and Turbo decoder for error correction decoding.

The demodulator 216 typically will support an array of different MIMO detection algorithms, including algorithms for supporting NAICS receiver, to cover different transmission modes. To detect a single layer MIMO signal, the Maximum Ratio Combining (MRC) algorithm can be used. To detect MIMO with 2 or more layers, Minimum Mean Squared Error (MMSE) algorithm, or Maximum Likelihood (ML) algorithm, or Sphere Decoding (SD) algorithm can be used. There are many different kinds of SD algorithms, including two categories of depth-first and breadth-first algorithms. One particular depth-first algorithm is called SESD (Schnorr-Euchner Sphere Decoding) which, in addition to using depth-first tree-search, also converts complex-valued MIMO into its equivalent real-valued MIMO system before the detection. The MMSE algorithm has much lower complexity compared to ML and SD algorithm, and additionally often exhibits better error rate performance than ML or SD at low Signal-to-Interference-and-Noise-Ratio (SINR). Therefore, using MMSE at low SINR not only could reduce consumption, but also increase throughput. At high SINR, on the other hand, ML or SD algorithm can outperform MMSE by big margin and the receiver should select either ML or SD algorithm to get high throughput. To detect interference signal in addition to detecting the desired signal, the demodulator also supports NAICS algorithms including NAICS MMSE-SIC and NAICS ML algorithms.

Different MIMO detection techniques, including NAICS detection algorithms, can be categorized based on their design criteria and impairment models. In the present description, techniques that use uncorrelated impairment model are referred to as standard algorithms whereas techniques that use correlated impairment model are referred to as IRC algorithms. These standard algorithms do not take into account the impairment correlation in the signals received at the different antennas. For example, the algorithm which minimizes MSE using uncorrelated impairment model is referred to as standard MMSE or simply MMSE algorithm, and the algorithm which also minimizes MSE but uses correlated model is referred to as MMSE-IRC (see Table 1).

The ML, ML-IRC, SD, and SD-IRC are all algorithms that are based on the ML criterion. SD/SD-IRC typically have lower complexity compared to ML/ML-IRC, because, in SD/SD-IRC algorithm, the search for the ML solution is confined to those vectors x that lie within a hyper sphere with a specific search radius. In other words, the search space is limited.

Table 1 lists various signal detection algorithms that have been categorized based on the design criterion and the impairment model assumed.

TABLE 1
detection algorithms based on design criterion and impairment model

| | | Impairment | |
|---|---|---|---|
| | Criterion | model | Detection formula |
| MRC | Maximize | Uncorrelated | \hat{x}_{MRC} = H^{H}y |
| | SNR | | (10-1) |
| IRC | Maximize | Correlated | \hat{x}_{IRC} = H^{H}R⁻¹y |
| | SNR | | (10-2) |
| MMSE | Minimize | Uncorrelated | \hat{x}_{MMSE} = (H^{H}H + δ²I)⁻¹H^{H}y |
| | MSE | | (10-3) |
| MMSE-IRC | Minimize | Correlated | \hat{x}_{MMSE-IRC} = (H^{H}R⁻¹H + δ²I)⁻¹H^{H}R⁻¹y |
| | MSE | | |
| ML | Maximize AP | Uncorrelated | ${\hat{x}}_{ML} = arg {min}_{x ∈ {C}^{{N}_{L}}} {( y - Hx )}^{H} ( y - Hx )$ (10-5) |
| ML-IRC | Maximize AP | Correlated | ${\hat{x}}_{ML \text{-} IRC} = arg {min}_{x ∈ {C}^{{N}_{L}}} {( y - Hx )}^{H} {R}^{- 1} ( y - Hx )$ (10-6) |
| SD | Maximize AP | Uncorrelated | ${\hat{x}}_{SD} = arg {min}_{x ∈ Ω} {( y - Hx )}^{H} ( y - Hx )$ (10-7) |
| SD-IRC | Maximize AP | Correlated | ${\hat{x}}_{SD \text{-} IRC} = arg {min}_{x ∈ Ω} {( y - Hx )}^{H} {R}^{- 1} ( y - Hx )$ (10-8) |
| NAICS-MMSE-SIC | Minimize | Uncorrelated | Same a MMSE, but channel matrix consists of |
| | MSE | | both interference and desired signal matrix, and |
| | | | needs to be updated after each interference |
| | | | cancellation step. |
| NAICS-MMSE-SIC-IRC | Minimize | Correlated | Same as above |
| | MSE | | |
| NAICS-ML | Maximize | Uncorrelated | Same a ML, but channel matrix consists of both |
| | AP | | interference and desired signal channel. |
| NAICS-ML-IRC | Maximize | Correlated | Same as above. |
| | AP | | |

It can be seen from Table 1 that, in one aspect, implementing different IRC algorithms amounts to incorporating the inverse of the impairment covariance matrix R⁻¹ into the corresponding standard algorithms. However this method of implementing IRC algorithms by changing the individual algorithms will cause very large increase in chip area, computational complexity, and power consumption. For covering all operational cases, a receiver typically will support both IRC and non-IRC mode operation, because the IRC gain depends on the prevalent interference situation. Using IRC mode detection when the mobile terminal is in the cell center region, for example, can reduce rather than increase the data throughput due to errors in the channel and impairment covariance matrix estimation. This means all formulas in Table 1 would typically be explicitly or implicitly implemented. It can be seen that an IRC algorithm implies significantly more computation compared to the corresponding standard algorithm. For example, demodulating using MMSE-IRC (10-4 in Table 1) uses more computation than using standard MMSE algorithm (10-3 in Table 1).

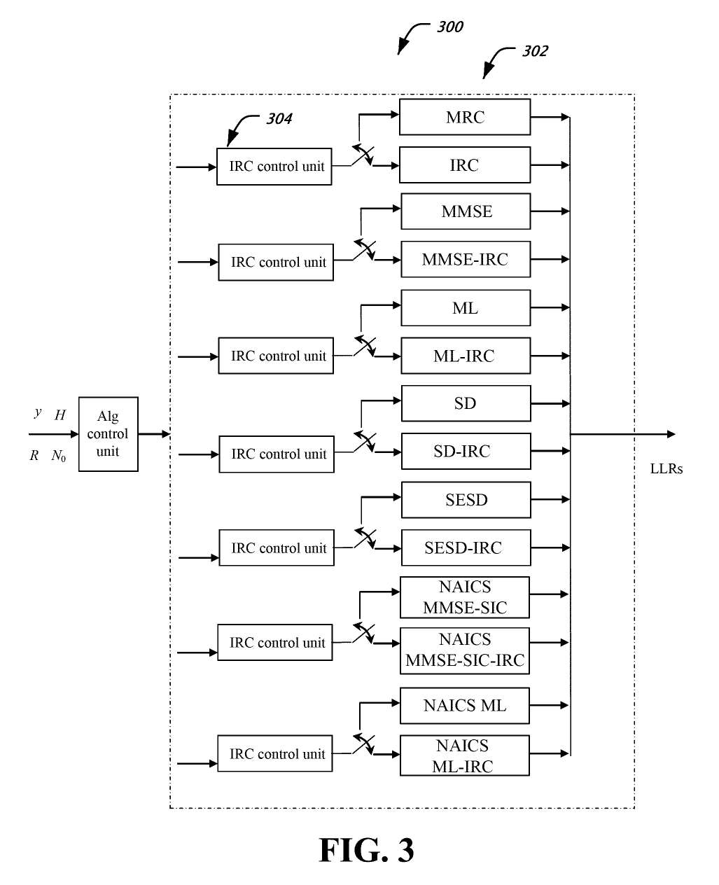

FIG. 3 shows an example of a MIMO IRC demodulator 300 in which various receiver-side techniques are shown as independent modules 302. In many practical implementations, in order to achieve the optimum detection results at various channel conditions, each of these modules is often implemented with a dedicated circuitry. In other words, while the receiver is receiving signals, the receiver may have made a decision to use a specific signal detection technique, e.g., ones listed in Table 1. For example, the IRC control unit 304 may make the decision about whether or not to use IRC. As discussed in this document, such strategy fails to be amenable to changes to detection techniques. For example, including a new detection technique or updating and modifying the algorithmic details of an existing signal detection technique may require significant change to the implementations—e.g., silicon re-design and re-fabrication. Such changes could be expensive and could take a long time to redesign and re-fabricate the products.

Some disclosed embodiments circumvent the problems by first removing the spatial correlation of the impairment in the received signal by passing the received signal and the channel matrix through a whitening filter. The whitened received signal and channel matrix are then fed to the selected standard algorithm. In some implementations, all standard detection algorithms share the same whitening filter. Thus, only a single whitening filter is used to support IRC detection for all the algorithms that have been optimized for the various operating conditions. To support adaptive IRC and none-IRC mode detection, the demodulator can include an IRC switch which can be turned on or off depending on an operational parameter, e.g., the degree of impairment correlation, antenna configuration, etc. When the switch is turned off, the whitening filter unit is bypassed, and received signal and channel matrix are fed directly to the selected standard algorithm.

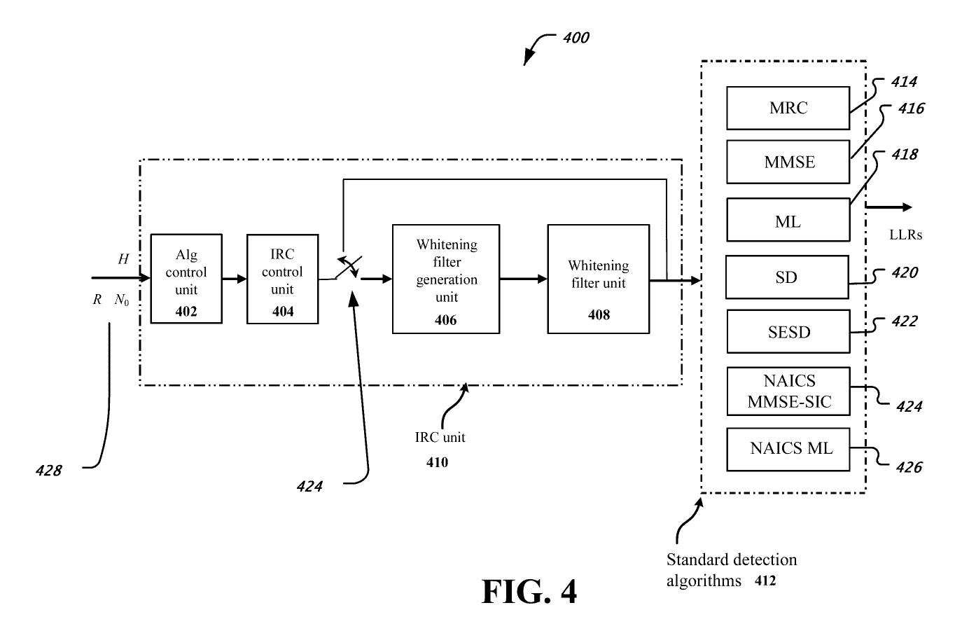

An example embodiment of MIMO demodulator 400, shown in FIG. 4, comprises an IRC unit 410 that includes an algorithm control unit 402, a IRC control unit 404, a whitening filter generation unit 406, and a whitening filter unit 408. Signals, including interference and noise, 428 received at the multiple antennas are fed to the demodulator 400. The output of the whitening filter unit 408 can be connected to any of the modules that implements a standard detection algorithm (collectively represented as 412), e.g., MRC module 414, MMSE module 416, ML module 418, SD module 420, SESD module 422, NAICS MMSE-SIC module 424, NAICS ML module 426, etc. For example, if MMSE module 416 is selected, the output from the whitening filter unit are fed to the standard MMSE module 416.

The spatial whitening filter generated by the whitening filter generation unit 406 can be obtained by computing the Cholesky decomposition of the inverse of the impairment covariance matrix R⁻¹=U^{H}U and multiplying the received signal y and channel matrix H by the factor matrix U to obtain a whitened received signal y_{w} and the corresponding channel matrix H_{w}, resulting in the following equivalent system

y_{w}=Uy=U(Hx+n)=UHx+Un=H_{w}x+n_{w} Eq. 10

The whitening operation is used to transform the original MIMO system y=Hx+n with correlated impairment n into a new MIMO system y_{w}=H_{w}x+n_{w} with uncorrelated or white impairment n_{w}. Using the definition of the whitening filter, R⁻¹=U^{H}U the whiteness of the new impairment n_{w}=Un can be easily proved:

R_{w}⁻=E{n_{w}n_{w}^{H}}=E{Unn^{H}U^{H}}=UE{nn^{H}}U^{H}=URU^{H}=UU⁻¹U^{-H}U^{H}=I_{N}_{_{RX}} Eq. 11

Eq. 11

Eq. 11 shows that the variance of n_{w} is always 1.0 no matter what the original impairment matrix is. This fact can be utilized to simplify the detection process.

In some implementations, cascading the whitening filter with a standard algorithm is equivalent to the corresponding IRC algorithm. More specifically, cascading the whitening filter with the MMSE algorithm can be equivalent to the MMSE-IRC algorithm, and cascading the whitening filter with the SD algorithm can be equivalent to the SD-IRC algorithm, and so on. Regarding MMSE-IRC, the equivalence can be proved by feeding the output from the whitening filter y_{w}=Uy, H_{w}=UH and δ²=1.0 to the standard MMSE algorithm which computes estimate \hat{x} using (10-3 in Table 1), i.e. \hat{x}=+(H_{w}^{H}H_{w}+δ²I_{N}_{_{TX}})⁻¹H_{w}^{H}y_{w}. Replacing H_{w} with UH, y_{w} with Uy, δ² with 1.0 and U^{H}U with R⁻¹ yields:

\hat{x}=(H^{H}U^{H}UH+I_{N}_{_{TX}})⁻¹H^{H}U^{H}Uy=(H^{H}R⁻¹H+I_{N}_{_{TX}})⁻¹H^{H}R⁻¹y=\hat{x}_{MMSE-IRC} Eq. 12

Regarding ML-IRC, the equivalence can be proved by feeding the output of the whitening filter y_{w}=Uy and H_{w}=UH to the standard ML algorithm which computes estimate \hat{x} using (10-5 of Table 1), i.e.

$$\hat{x} = arg {min}_{x ∈ {C}^{{N}_{L}}} {( {y}_{w} - {H}_{w} x )}^{H} ( {y}_{w} - {H}_{w} x ) .$$

Replacing H_{w} with UH and y_{w} with Uy, and U^{H}U with R⁻¹ yields:

$$\begin{matrix}\hat{x} = arg {min}_{x ∈ {C}^{{N}_{L}}} {( {y}_{w} - {H}_{w} x )}^{H} ( {y}_{w} - {H}_{w} x ) \\ = arg {min}_{x ∈ {C}^{{N}_{L}}} {‖ U ( y - H ) x ‖}^{2} \\ = arg {min}_{x ∈ {C}^{{N}_{L}}} {( y - Hx )}^{H} {R}^{- 1} ( y - Hx ) \\ = {\hat{x}}_{ML - IRC}\end{matrix} \qquad Eq . 13$$

The equivalence for other IRC algorithms can be proved in a similar way.

FIG. 4 shows an exemplary embodiment of MIMO IRC demodulator 400, comprising an algorithm control unit 402, an IRC control unit 404, a whitening filter generation unit 406 and a whitening filter unit 408. Based on the operating conditions, the algorithm control unit 402 selects the optimum algorithm, MMSE, ML, SD, NAICS MMSE-SIC, etc. The decision about which algorithm to select may be based on SINR and other signal parameters. The IRC control unit 404 calculates an interference reduction metric M and compares the metric with a threshold T to determine if IRC should be enabled. In some embodiments, the interference reduction metric may be related to a value of impairment spatial correlation in the signals received at different antennas.

In some embodiments, the whitening filter generation unit 406 calculates a whitening filter by performing a Cholesky decomposition of the inverse of the impairment covariance matrix. The whitening filter unit 408 then applies the whitening filter to the received signal and channel matrix.

In some embodiments, the IRC control unit calculates an interference reduction ratio based on the estimated impairment correlation matrix and compares the metric with a threshold to determine if IRC should be applied. The threshold T can be chosen based on the result of simulations, while taking the values of other relevant signal parameters into account such as the estimated SINR, the modulation scheme, and so on. For example, the threshold T may be a system-wide constant or may be periodically adjusted based on changes in the wireless network.

In some embodiments, the whitening filter can be generated by first computing the Cholesky decomposition of the impairment covariance matrix and then computing the inverse of the triangular Cholesky factor matrix followed by conjugate-transposing the result. This method can be used to reduce the computation compared to first computing the inverse of R matrix and then performing Cholesky decomposition of the inverse. This is because inverting a triangular matrix is much simpler than inverting a non-triangular matrix. An additional benefit of this method is that, after the Cholesky decomposition of the impairment matrix has been computed, the determinant of the impairment covariance matrix is readily obtained by computing the product of the main diagonal entries of the Cholesky factor matrix and squaring the result. The determinant of the impairment covariance matrix is then used for calculating the interference reduction metric.

In various embodiments, the Cholesky factorization that is calculated using either upper or lower triangular factor matrix can be used to obtain the whitening filter. In both cases, the impairment will be de-correlated whether upper or lower triangular matrix is used. If the power levels of the impairment on receive antennas are very different, however, using upper or lower triangular matrix will have a different effect on the received signals. Consider the case of using 2 receive antennas with:

$$y = {[ y ( 0 ) , y ( 1 ) ]}^{T} , U = [ \begin{matrix}{u}_{00} & {u}_{01} \\ 0 & {u}_{11}\end{matrix} ] , L = [ \begin{matrix}{l}_{00} & 0 \\ {l}_{10} & {l}_{11}\end{matrix} ] and R = [ \begin{matrix}{r}_{00} & {r}_{01} \\ {r}_{10} & {r}_{22}\end{matrix} ] \qquad Eq . 14$$

In case when upper-triangular whitening filter is used to whiten received signal y_{w} iS:

$${y}_{w} = [ \begin{matrix}{u}_{00} & {u}_{01} \\ 0 & {u}_{11}\end{matrix} ] [ \begin{matrix}y ( 0 ) \\ y ( 1 )\end{matrix} ] = [ \begin{matrix}{u}_{00} y ( 0 ) + {u}_{01} y ( 1 ) \\ {u}_{11} y ( 1 )\end{matrix} ] \qquad Eq . 15$$

If lower-triangular whitening filter is used, then the whitened received signal y_{w} is:

$${y}_{w} = [ \begin{matrix}{l}_{00} & 0 \\ {l}_{10} & {l}_{11}\end{matrix} ] [ \begin{matrix}y ( 0 ) \\ y ( 1 )\end{matrix} ] = [ \begin{matrix}{l}_{00} y ( 0 ) \\ {l}_{10} y ( 0 ) + {l}_{11} y ( 1 )\end{matrix} ] \qquad Eq . 16$$

From Equations 15 and 16, it can be seen that in case of upper-triangular filter, the signal y_{w}(1) is the scaled version of the original signal y(1) whereas the signal y_{w}(0) is the linear combination of y(0) and y(1). Similarly, in case of lower triangular filter, y_{w}(0) is the scaled version of y(0), whereas y_{w}(1) is the linear combination of y(0) and y(1). In some embodiments, if the impairment power on the second antenna is smaller, i.e. if r₁₁<r₀₀, then upper-triangular filter may be used; otherwise lower triangular filter is used. This selectivity of the application of whether to use the upper or the lower triangular filter can be advantageously used to minimize the distortion to the received signal branch that has better quality.

In one aspect, the performance gain of IRC can be measured in terms of SINR to achieve a certain normalized throughput (for example 70%) with and without using IRC. The figure of IRC gain depends on many factors, including location of the mobile terminal, dominant interference power ratio (DIP), which is the ratio of each interferer's power level to the total interference plus thermal noise power, the estimation accuracy of channel, and impairment covariance matrix, etc. The IRC gain also improves very significantly with increased number of receive antennas, because using more receive antennas enables the receiver to more fully de-correlate the impairment and to reduce the effects of interference to a larger extent.

In some embodiments, if a mobile terminal has only 2 receive antennas, real-valued impairment covariance matrix can be generated by splitting the in-phase (I) and quadrature (Q) component of each impairment sample e_{l,k}=[re(e_{l,k})^{T}, im(e_{l,k})^{T}]^{T} where re(e_{l,k})=[re(e_{l,k}(0),re(e_{l,k}(1),..re(e_{l,k}(N_{RX}−1]^{T}, im(e_{l,k})=[im(e_{l,k}(0),im(e_{l,k}(1),..im(e_{l,k}(N_{RX}−1)]^{T}, e_{l,k}=y_{l,k}=Hd_{l,k} and (l,k)⊂Ψ_{RS}. It can be seen that ē_{l,k} is a 2 N_{RX}×1 vector. Averaging these vector samples yields the 2 N_{RX}×2 N_{RX} real-valued impairment covariance matrix R̅:

$$\overline{R} = \frac{1}{\vert {Ψ}_{RS} \vert} {\sum }_{( l , k ) ∈ {Ψ}_{RS}} {\overline{e}}_{l , k} {\overline{e}}_{l , k}^{T} \qquad Eq . 17$$

Using I-Q splitting, the impairment correlation in both antenna and I-Q domain are captured which is especially beneficial when the number of receive antennas is small such as 2. The whitening filter is generated from R̅ by computing the Cholesky decomposition of R̅

R̅⁻¹=Ū^{T}Ū Eq. 18

Before the whitening filter Ū can be applied to the received signal, the original complex-valued MIMO system y=Hx+n is transformed to its equivalent real-valued MIMO system:

y̅=H̅x̅+n̅, where

$$\overline{H} = [ \begin{matrix}re ( H ) & - im ( H ) \\ im ( H ) & re ( H )\end{matrix} ] , \overline{y} = [ \begin{matrix}re ( y ) \\ im ( y )\end{matrix} ] , \overline{x} = [ \begin{matrix}re ( x ) \\ im ( x )\end{matrix} ] , \overline{n} = [ \begin{matrix}re ( n ) \\ im ( n )\end{matrix} ] \qquad Eq . 19$$

The whitened received signal y̅_{w} and channel matrix H̅_{w} are given by

y̅_{w}=Ūy̅ and H̅_{w}=Ūy̅. Eq. 20

Eq. 20

This method of spatial whitening using the real-valued impairment covariance matrix is especially convenient when the SESD algorithm is selected, because the SESD algorithm is also based on converting the complex MIMO to its equivalent real system before detecting. After the whitening operation, the above-described MIMO system has already been converted to a real system, thereby providing partial results for the SESD implementation.

One advantageous aspect of the techniques disclosed in the present document is that these techniques can significantly reduce computation complexity, when compared with the complexity of an implementation in which the inverse of impairment matrix R⁻¹ is directly incorporated into the respective detection method.

In some embodiments using the presently disclosed techniques, computations for a whitening operation may be performed. These computations may include multiplication of the received signal vector and channel matrix by a triangular matrix which has real diagonal elements with all elements below the diagonal being zero, i.e., not needing a multiplication. See, e.g., discussion with respect to Equations 15 and 16. When using the direct method, the additional computation load for IRC based detection involves the multiplication of the received signal vector and channel matrix by the inverse of the impairment correlation matrix which typically has no zero elements.

It is the zeros in the triangular matrix, which represents the whitening filter, that contribute to the computational saving. The savings are larger with an increasing number of receive antennas and with the size of channel matrix. For example, if there are 8 receive antennas and the channel matrix is 8×8, then there are 28 zeros in the triangular whitening filter matrix which will result in a saving of 28*9 complex multiplications per sub-carrier. Each complex multiplication may be performed using 4 real multiplications and 2 real additions or 6 real operations. The saving per subcarrier is thus 28*9*6 operations. For a LTE system with 1200 data carrying subcarriers, the total saving per packet can be 28*9*6*1200=1,814,400 operations.

The above savings calculations are applicable to the MMSE-IRC implementation. For ML-IRC and SD-IRC implementations, the savings can be even more because using the direct implementation method, the full matrix R⁻¹ needs to be multiplied |C|^{N}^{_{D}} times by a N_{RX}×1 vector where |C| is the number of modulation alphabet size and N_{D} is the number of transmitted layers and N_{RX} is the number of receive antennas. Using 64-QAM and N_{D}=8 as an example, the additional computation complexity is 64⁸ complex vector-matrix multiplications which is impractical to implement using the existing technology. By contrast, using the techniques disclosed in the documents, the additional computation is exactly the same as with MMSE-IRC, i.e., multiplication of the received signal and channel matrix by the triangular whitening filter matrix.

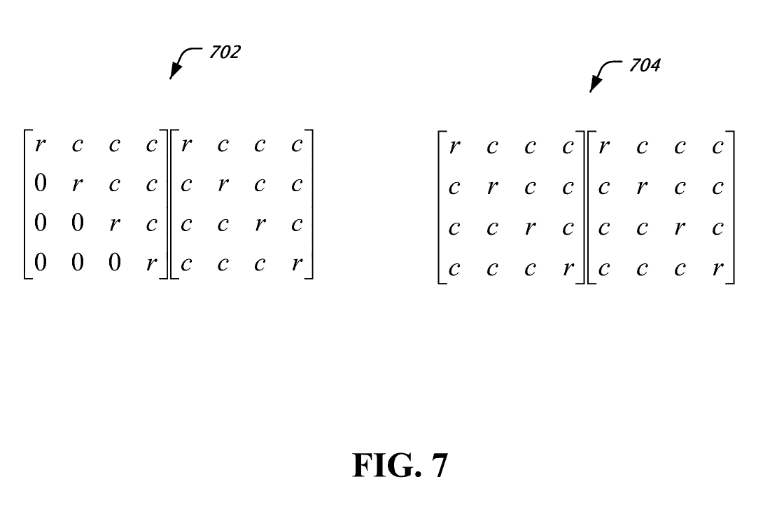

The difference between the computation load using a unified IRC scheme and direct implementation is depicted in the example matrix depictions of FIG. 7. The matrix 702 depicts the use of a triangular matrix that can be used to multiple a 4×4 channel matrix H, e.g., in the unified IRC methods described in this document, where the additional computation per carrier is a matrix multiplication where the left matrix is the triangular whitening filter matrix. The matrix 704 depicts a full matrix that multiplies a 4×4 channel matrix H in which case additional computation is also a matrix multiplication but both matrices don't have any zero elements.

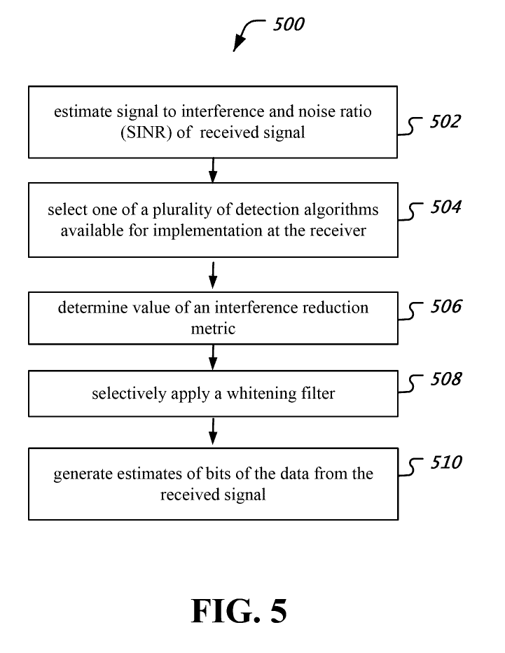

FIG. 5 shows an example flowchart of a method 500 for recovering data from a received modulated signal. The method 500 may be implemented, e.g., in a receiver device that has multiple receive antennas.

At 502, the method 500 estimating a signal to interference and noise ratio (SINR) of a received signal.

At 504, the method 500 includes selecting, based on the estimated SINR, one of a plurality of detection algorithms available for implementation at the receiver

At 506, the method 500 includes determining a value of an interference reduction metric.

At 508, the method 500 includes selectively applying a whitening filter to the received signal, wherein the whitening filter is applied only when the value of the interference reduction metric meets a switching criterion. In some embodiments, the method 500 may estimate the coefficients of the whitening filter by estimating an impairment covariance matrix for received signals and computing a Cholesky decomposition of inverse of the impairment covariance matrix.

At 510, the method 500 includes passing a resulting signal of the selective application of the whitening filter to a module that implements the selected detection algorithm to recover data bits from the received signal.

In some embodiments, a wireless communication receiver to adaptively demodulate a received signal includes an algorithm control unit that selects one from a plurality of signal detection algorithms available at the receiver, an interference rejection combining control unit that determines whether or not to use IRC for demodulation of a received signal using the selected detection algorithm, a whitening filter generation unit that computes coefficients of a whitening filter from an impairment correlation matrix, and a whitening filter unit that performs the whitening prior to signal detection by the selected one of the plurality of signal detection algorithms.

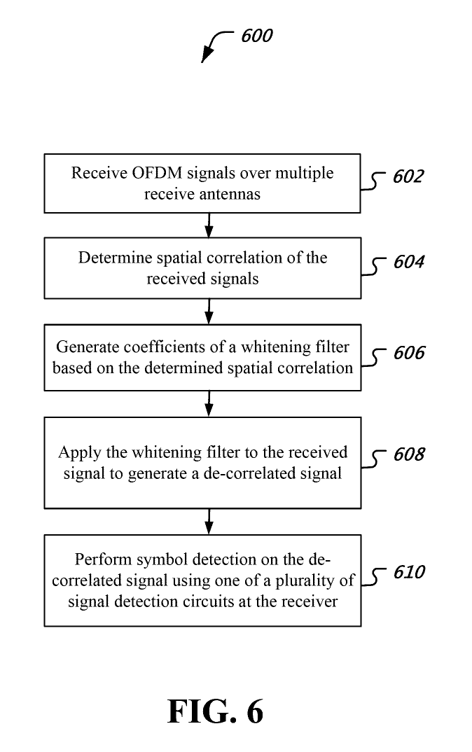

FIG. 6 shows an example method 600 of receiving modulated data bits. The method 600 includes receiving an OFDM signal over multiple antennas (602), determining a spatial correlation of the impairment in the received signals (604), generating coefficients of a whitening filter based on the determined impairment spatial correlation (606), applying the whitening filter to the received signal for de-correlating the impairment in the received signal (608), and performing symbol detection on the de-correlated signal using one of a plurality of standard signal detection circuits (610). For example, the signal detection circuits may implement “standard” algorithms as disclosed in the present document. In some embodiments, the whitening filter is computed by estimating an impairment covariance matrix based on signal received at each of the multiple antennas, wherein the impairment covariance matrix is an N_{RX}×N_{RX} matrix (e.g., Eq. 4), performing a Cholesky decomposition of the impairment covariance matrix, and inverting the Cholesky factor matrix to obtain the whitening filter.

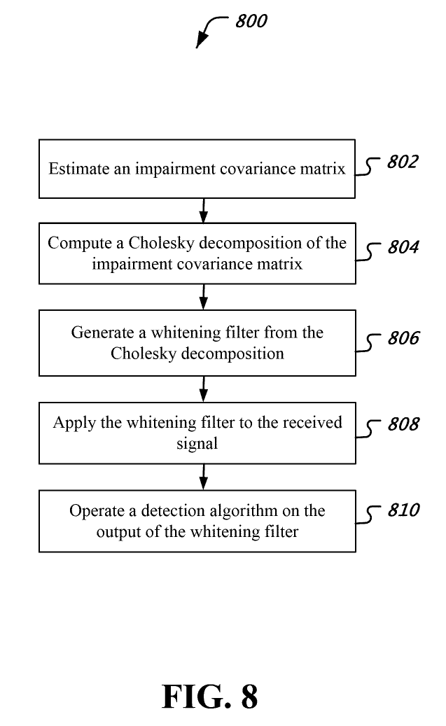

FIG. 8 depicts an example method 800 of recovering data from a received signal that includes an interference component may be implemented at a receiver comprising multiple receiving antennas. The method 800 includes estimating (802), at the receiver, an impairment covariance matrix for signals received at the multiple receiving antennas. The impairment covariance matrix represents a statistical covariance of the interference plus noise component of the received signal. Equation 7 shows an example representation of the impairment covariance matrix that can be calculated during implementation of method 800.

The method 800 further includes computing (804) a Cholesky decomposition of the impairment covariance matrix by using one of an upper- and a lower- triangular Cholesky factor matrix depending on relative power levels of impairment component of the signals received at the multiple receiving antennas. For example, referring to discussion with reference to Equations 15 and 16, the whitened component y_{w}() of the input signal may be dominated by the corresponding received signal, or may be a combination of signals received at different antennas, based on the upper or lower triangular characterization of the Cholesky decomposition.

The method 800 further includes generating (806) a whitening filter from the Cholesky decomposition. The whitening filter de-correlates received interference over the multiple receiving antennas by using spatial correlation of the impairment signals across the multiple receiving antennas. The method 800 further includes applying (808) the whitening filter to the received signal. The method 800 further includes operating (810) a detection algorithm upon an output of the whitening filter to generate estimates of bits of the data from the received signal.

In some embodiments, the the interference component is represented as a vector of dimension N_{RX}×1, wherein N_{RX} corresponds to number of receive antennas of the receiver. The method 800 may use the upper triangular Cholesky factor matrix when a measure of bottom entries in the vector is smaller than the measure of top entries in the vector. In some embodiments, the measure represents magnitude of a corresponding diagonal covariance coefficient entry in the impairment covariance matrix. For example, an example embodiment for 2 receive antennas is discussed in this document with reference to Equations 15 and 16.

It will be appreciated that techniques disclosed in the present document could be used to incorporate multiple IRC-based signal reception techniques without paying significant increase in circuit complexity or power consumption.

It will further be appreciated that techniques are disclosed to allow a reduced complexity implementation of the whitening filter by avoiding having to perform inversion of an impairment correlation matrix by first computing the Cholesky decomposition of the correlation matrix followed by inverting the Cholesky factor matrix that is triangular.

It will further be appreciated that the disclosed techniques can be used by implementers to enhance their current hardware implementations of non-IRC based, or standard, signal detection and decoding algorithms with IRC functionality.

The disclosed and other embodiments, modules and the functional operations described in this document can be implemented in digital electronic circuitry, or in computer software, firmware, or hardware, including the structures disclosed in this document and their structural equivalents, or in combinations of one or more of them. The disclosed and other embodiments can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this document can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

While this patent document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few examples and implementations are disclosed. Variations, modifications, and enhancements to the described examples and implementations and other implementations can be made based on what is disclosed.

What is claimed is what is described and illustrated, including:

1. A method of recovering data from a received signal implemented at a receiver comprising multiple receiving antennas, the method comprising:
estimating a signal to interference and noise ratio (SINR) of a received signal;
selecting, based on the estimated SINR, one of a plurality of detection algorithms available for implementation at the receiver;
determining a value of an interference reduction metric;
selectively applying a whitening filter to the received signal, wherein the whitening filter is applied only when the value of the interference reduction metric meets a switching criterion; and
operating the selected one of the plurality of detection algorithms upon an output of the whitening filter to generate estimates of bits of the data from the received signal;
wherein at least some of the plurality of detection algorithms have different error rate performances and different computational complexities; and
wherein the whitening filter de-correlates received impairment over the multiple receiving antennas by using spatial correlation of the impairment across the multiple receiving antennas.

2. The method of claim 1, further including:
estimating, at the receiver, an impairment covariance matrix for signals received at the multiple receiving antennas;
computing a Cholesky decomposition of the impairment covariance matrix; and
generating a whitening filter.

3. The method of claim 2, wherein the estimating the impairment covariance includes averaging impairment samples wherein each impairment sample is calculated by subtracting from a received Reference Signal (RS) the contribution from the serving cell, and if one of the Network Assisted Interference Cancellation and Suppression (NAICS) algorithms is selected, the contribution from one or more neighbor cells.

4. The method of claim 2, wherein the computing the Cholesky decomposition of the inverse of impairment covariance matrix comprises using an upper- or a lower- triangular Cholesky factor matrix depending on relative power levels of impairment signals received at the multiple receiving antennas.

5. The method of claim 4, wherein determining the relative power levels of the impairment signals comprises comparing main diagonal entries of the impairment covariance matrix.

6. The method of claim 2, wherein the computing the Cholesky decomposition of the inverse of impairment covariance matrix comprises first computing the inverse of the impairment covariance matrix and then computing the Cholesky decomposition of the inverted matrix.

7. The method of claim 2, wherein the computing the Cholesky decomposition of the inverse of impairment covariance matrix comprises first computing a triangular Cholesky decomposition of the impairment covariance matrix, and then computing an inverse of the triangular Cholesky factor matrix followed by a conjugate-transpose of the result.

8. The method of claim 2, wherein generating the whitening filter includes multiplying a vector comprising the received signal by the Cholesky factor matrix to obtain a whitened signal.

9. The method of claim 8, further including multiplying a matrix representative of the channel by the Cholesky factor matrix to obtain a whitened channel matrix estimate.

10. The method of claim 2, wherein the generating the whitening filter comprises using real-valued impairment covariance matrix to double a dimension of the impairment covariance matrix and to de-correlate impairment simultaneously both in spatial or antenna and in in-phase (I) and quadrature component (Q) domains.

11. The method of claim 10, wherein doubling the dimension of impairment covariance matrix comprises splitting an in-phase (I) and a quadrature component (Q) of the impairment sample vectors and averaging the sample vectors in time and frequency to compute the said real-valued impairment covariance matrix.

12. The method of claim 10, wherein whitening filter based on real-valued impairment covariance matrix comprises transforming the complex-valued multi-input, multi-output (MIMO) system into the equivalent real-valued MIMO system before applying the whitening filter.

13. The method of claim 2, wherein the generating the whitening filter comprises using complex-valued impairment covariance matrix to generate the whitening filter.

14. The method of claim 1, further comprising passing whitened received signal and whitened channel matrix to the selected standard detection algorithm.

15. The method of claim 1, wherein the determining whether to enable or disable interference rejection combining comprises computing an interference reduction metric and comparing the metric with a threshold.

16. The method of claim 14, wherein the interference reduction metric is based on the impairment correlation matrix by computing the ratio between the determinant of the impairment covariance matrix and the product of the main diagonal entries of the impairment covariance matrix.

17. The method of claim 14, wherein the interference reduction ratio is compared with a threshold to determine whether or not interference rejection combining is to be applied wherein the threshold value can be determined based on the modulation scheme used and a signal to interference and noise ratio (SINR).

18. The method of claim 14, wherein the interference rejection combining is enabled if the interference reduction metric meets a switching criteria, for example, when the interference reduction metric is smaller than the threshold, and otherwise, if the interference reduction metric is equal to or larger than the threshold, interference rejection combining is disabled.

19. A wireless communication receiver to adaptively demodulate a received signal, comprising:
an algorithm control unit that selects one from a plurality of signal detection algorithms available at the receiver;
an interference rejection combining (IRC) control unit that determines whether or not to use interference rejection combining for demodulation in which spatial correlation of impairment component of the received signal is utilized for demodulation;
a whitening filter generation unit that computes coefficients of a whitening filter from an impairment correlation matrix; and
a whitening filter unit that performs, prior to signal detection by the selected one of the plurality of signal detection algorithms, signal filtering using the whitening filter.

20. The wireless communication receiver of claim 19, wherein the algorithm control unit selects one of the plurality of detection algorithms available to the receiver based on an estimate of the signal to interference and noise ratio of the received signals.

21. The wireless communication receiver of 19, wherein the IRC control unit comprises a metric calculator for calculating an interference reduction metric and comparing the metric with a threshold to determine whether interference rejection combing should be used in the detection process.

22. The wireless communication receiver of claim 19, wherein the whitening filter generation unit includes a comparator configured to compare the impairment power levels on different receive antennas to generate a whitening filter using either upper- or lower-triangular Cholesky factor matrix.

23. A method of decoding data modulated using an orthogonal frequency division multiplexing (OFDM) technique implemented at a receiver having multiple receive antennas, comprising:
receiving the OFDM signal over the multiple antennas;
determining a spatial correlation of an impairment component of the received signals;
generating coefficients of a whitening filter based on the determined spatial correlation;
applying the whitening filter to the received signal for de-correlating the impairment component of the received signal; and
performing symbol detection on the de-correlated signal using one of a plurality of signal detection circuits that do not use impairment spatial correlation.

24. The method of claim 23, wherein the generating the coefficients of the whitening filter includes:
estimating an N_{RX}×N_{RX} impairment covariance matrix based on signal received at each of the multiple antennas, wherein N_{RX} corresponds to number of receive antennas of the receiver;
performing a Cholesky decomposition of the impairment covariance matrix; and
inverting the Cholesky factor to obtain the whitening filter.

25. The method of claim 24, wherein the Cholesky factor comprises a triangular matrix.

26. A method of recovering data from a received signal that includes an interference component, implemented at a receiver comprising multiple receiving antennas, the method comprising:
estimating, at the receiver, an impairment covariance matrix for signals received at the multiple receiving antennas, wherein the impairment covariance matrix represents a statistical covariance of the interference component of the received signal;
computing a Cholesky decomposition of the impairment covariance matrix by using one of an upper- and a lower- triangular Cholesky factor matrix depending on relative power levels of impairment component of the signals received at the multiple receiving antennas;
generating a whitening filter from the Cholesky decomposition, wherein the whitening filter de-correlates received interference over the multiple receiving antennas by using spatial correlation of the impairment across the multiple receiving antennas;
applying the whitening filter to the received signal; and
operating a detection algorithm upon an output of the whitening filter to generate estimates of bits of the data from the received signal.

27. The method of claim 26, wherein the interference component is represented as a vector of dimension N_{RX}×1 with, wherein N_{RX} correspond to number of receive antennas of the receiver, and wherein the upper triangular Cholesky factor matrix is used when a measure of bottom entries in the vector is smaller than the measure of top entries in the vector.

28. The method of claim 27, wherein the measure represents magnitude of a corresponding diagonal covariance coefficient entry in the impairment covariance matrix.

29. A digital communication receiver apparatus comprising multiple received antennas, a memory, and a processor, wherein the apparatus performs a method of recovering data from signals received at the multiple antennas, wherein the signals include an interference component, the method comprising:
estimating, at the receiver, an impairment covariance matrix for signals received at the multiple receiving antennas, wherein the impairment covariance matrix represents a statistical covariance of the interference component of the received signal;
computing a Cholesky decomposition of the impairment covariance matrix by using one of an upper- and a lower- triangular Cholesky factor matrix depending on relative power levels of impairment component of the signals received at the multiple receiving antennas;
generating a whitening filter from the Cholesky decomposition, wherein the whitening filter de-correlates received interference over the multiple receiving antennas by using spatial correlation of the impairment across the multiple receiving antennas;
applying the whitening filter to the received signal; and
operating a detection algorithm upon an output of the whitening filter to generate estimates of bits of the data from the received signal.

30. The apparatus of claim 29, wherein the interference component is represented as a vector of dimension N_{RX}×1 with N_{RX} corresponding to number of receive antennas of the receiver, and wherein the upper triangular Cholesky factor matrix is used when a measure of bottom entries in the vector is smaller than the measure of top entries in the vector.

31. The apparatus of claim 30, wherein the measure represents magnitude of a corresponding diagonal covariance coefficient entry in the impairment covariance matrix.
